(19) United States
(12) Patent Application Publication
(10) Pub. No.: US 2002/0170640 A1
(43) Pub. Date: Nov. 21, 2002

(54) Shock absorber wheel

(76) Inventor: Willard H. Schmidt, Albuquerque, NM (US)

Correspondence Address: Willard H. Schmidt, 2015 Altez NE, Albuquerque, NM, 87112, US

(21) Appl. No.: 09/833,112

(22) Filed: Apr. 12, 2001

(51) Int. Cl. B60B 9/18

(52) U.S. Cl. 152/56

(57) ABSTRACT

A vehicle wheel in which the inner annular shock absorber element (3) is located within the wheel itself and not in contact with the roadbed, as is the tire in prior art. The inner annular shock absorber element (3) may be a tube shaped annulus filled with air under pressure, or made from a solid resilient rubber compound. It is located within the wheel assembly between an outer annular rim (2) and an inner annular rim (4), both of which have concave surfaces to accommodate the shock absorber element (3). The tread (1) is located on the outer metal rim (2) at the periphery of the wheel and provides a friction surface in contact with the roadbed. It may be made from a solid rubber compound with grooves cut into it, or designs molded into it, to provide a friction surface. The hub assembly (6) is located at the center of the wheel, and it is rigidly connected to the inner metal rim (4) by the metal wheel support section (5).

### BACKGROUND

1. Field of Invention

This invention relates to transportation vehicle wheels, which are in contact with a roadbed.

2. Description of Prior Art

The wheels on most automobiles, trucks, aircraft, etc. commonly have a shock absorber element on the periphery of the wheel, and it is known as a tire. In the early days, the tire was solid and made of a hard rubber compound. Later, the tire was made of a rubber casing, inside of which was a rubber inner tube that was inflated with air pressure to provide a shock-absorbing cushion. It was mounted on a rim located on the periphery of the wheel. At one time, leather straps were made and fitted over the periphery of the tire to provide protection for the tire and minimize road wear to the tire tread and the tire casing. In later years the tire inner tube was eliminated, and the tire casing was designed to provide an airtight seal with the body of the wheel. Also, a tire tread consisting of a thick layer of rubber compound was vulcanized or sealed to the periphery of the tire casing to enhance the wear characteristics of the tire.

Present day vehicle tires, located on the periphery of the wheels, are pneumatic and filled with air under pressure. They constitute a significant safety hazard. They are vulnerable to wear and to road hazards which can cause a rapid decompression, or “blowout”, that can result in loss of control of the vehicle. This has lead to injury and death of the occupants of vehicles. There have been many manufacturer recalls of both tires and vehicles because of problems with vehicle tire safety.

### OBJECTS AND ADVANTAGES

The advantages of the Shock Absorber Wheel described in this patent are:

(a) to provide a wheel for a vehicle in which the major shock absorbing element is within the wheel itself, and not on the periphery of the wheel where it would be in contact with the roadbed and vulnerable to road wear and road obstructions, which in the past have resulted in major safety problems with tires on automobiles, trucks, and aircraft.

(b) to provide a vehicle wheel for which the tread, located on the periphery of the wheel in contact with the road-bed, is not in direct contact with the inner annular shock absorber element of the wheel, and, therefor, any damage to the tread, or tread wear, cannot effect the performance of the inner annular shock absorber element.

(c) to provide a vehicle wheel with an inner shock absorber element, located within the wheel itself and away from the periphery of the wheel, for which the risk of a “blowout”, or rapid loss of air pressure is made insignificant.

(d) to provide a vehicle wheel for which the shock absorbing ability is greater than that for the conventional prior art wheel with a peripheral pneumatic tire, because the direction of the shock absorber action for the subject patent wheel with an inner annular shock absorber element is reversed from that of the conventional peripheral tire.

(e) to provide a vehicle wheel construction which is more simple, less expensive, and safer to use than that of prior art.

(f) to provide an inner annular shock absorber element in a vehicle wheel which is integral within itself, and does not depend on or incorporate a rubber to metal air pressure seal to a rim or wheel for air pressure integrity, as does prior art.

(g) to provide an inner annular shock absorber element for a vehicle wheel which is integral in itself and does not have, or depend on, a tread that is vulcanized or cemented to it, as does prior art.

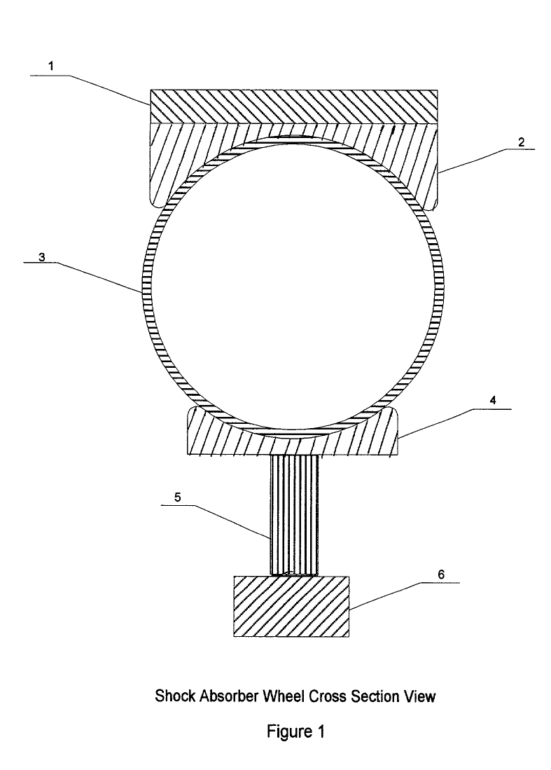

### DRAWING FIG. 1

The FIG. 1 drawing is a cross sectional view from the hub to the periphery of a vehicle wheel incorporating an inner annular shock absorber element and a peripheral solid rubber compound tread.

| Reference Numerals in Drawing | |
|---|---|
| 1 | tread |
| 2 | outer annular rim |
| 3 | inner annular shock absorber element |
| 4 | inner annular rim |
| 5 | wheel support section |
| 6 | wheel hub assembly |

### DESCRIPTION OF FIG. 1

Starting from the outer periphery of the wheel is the solid rubber composition tread 1. The outer surface of the tread has suitable groves cut or molded into it to provide traction with the roadbed as the wheel turns.

The tread 1 is bonded, cemented, or mechanically attached to the periphery of the annular shaped outer annular rim 2. The inner surface of the outer annular rim 2 is concave to permit the inner annular shock absorber element 3 to fit into it. The width of the outer annular rim 2 is made wide enough to accommodate the tread 1 and wide enough to fit over the inner annular rim 4 should it become necessary to do so.

The inner annular shock absorber element 3 is a hollow tubular annulus made of an expandable rubber compound which can be inflated with air pressure to fit in between the outer annular rim 2 and the inner annular rim 4.

The inner annular rim 4 is annular in shape with a concave outer surface to accommodate the inner annular shock absorber element 3 when it is inflated. The width of the inner annular rim 4 is less than that of the outer annular rim 2 to permit the inner rim 4 to fit within the outer rim 2 should that be necessary. The inner surface of the inner rim 4 is supported on the inner surface (facing the hub assembly) by virtue of its rigid attachment to the wheel support section 5.

The wheel support section 5 is the rigid metal structural section of the wheel between the inner annular rim 4 and the wheel hub assembly 6.

The wheel hub assembly 6 is located at the center of the vehicle wheel and contains the bearings that are in contact with the axle (not shown) of the wheel. The wheel hub assembly 6 is in rigid contact with the wheel support section 5.

Operation

The wheel for this patent operates in a manner similar to that for state of the art vehicle wheels in that it rotates on an axle secured to the vehicle, and the outer periphery is in contact with the roadbed. The wheel for this patent differs from prior art vehicle wheels that have the tire, or shock absorbing element, in contact with the roadbed, because in the subject patent wheel the inner annular shock absorber element 3 is located within the wheel itself and away from the periphery of the wheel. Therein lies a major safety advantage because the inner annular shock absorber element 3 which can contain air pressure is not vulnerable to road wear and road hazards that could otherwise result in deflation, or “blowout”, which may result in personal injury and property damage.

The solid rubber compound tread 1 on the periphery of the wheel is in contact with the roadbed. The surface of the tread can have grooves cut into it or certain designs molded into it to increase the frictional contact with the roadbed. The tread is secured to the outer annular rim 2 by vulcanizing, cementing, or by mechanical means.

The vehicle is cushioned from road shock by means of the inner annular shock absorber element 3 within the wheel and located between the inner 4 and outer 2 annular rims. This inner annular shock absorber element may be a hollow annular tube filled with air pressure or a solid rubber compound annulus extending around the wheel between the inner and outer annular rims. Roadbed shock to the wheel is attenuated by this inner annular shock-absorbing element. Unlike conventional prior art vehicle wheels, the road shock progresses from the hub of this patent wheel to the inner annular shock absorber element, rather from the roadbed directly to the tire, as in prior art vehicle wheels. This results in major safety advantage for this patent wheel.

The inner annular rim 4 is in solid contact with the hub assembly 6 of the wheel by means of the metal wheel support section 5.

This patent wheel is inherently safe, even in the event of depressurization of the inner annular shock absorber element 3, because the inner 4 and outer 2 annular rims can fit one into the other while the vehicle is brought to a stop.

Summary, Ramifications, and Scope

This patent wheel constitutes the latest major advance in the development of a wheel for transportation vehicles. It follows earlier developments, which eliminated the use of rubber tubes inside of vehicle tire casings, and which incorporated the use of a pneumatic seal between the tire and the metal wheel. Previous art is surpassed in this patent wheel by removing the pneumatic element (the tire) from the periphery of the wheel, where it is in contact with the roadbed, to a location inside of the wheel. The inner annular shock absorber element in this patent wheel provides enhanced shock absorbing action, and the shock forces due to the roadbed are directed to the inner annular shock absorber element from the wheel hub outward, rather than from the periphery of the wheel inward as in prior art. The result is a significant increase in safety to vehicle passengers over prior art with tire “blowout” problems, which have caused many deaths and injuries.

This wheel patent provides a vehicle wheel which will withstand much more severe road bed shock conditions than any prior art because of the manner in which the shock forces are distributed, and in the manner in which the inner annular shock absorber element is protected by the solid rubber compound tread on the periphery of the wheel. Consequently, this patent wheel is of great value for all vehicle wheels and especially for aircraft wheels where enormous shock forces are encountered on landing. Plane crashes due to tire “blowout” can be dramatically reduced with this patent wheel because the inner annular shock absorber element is not in contact with the runway, or with obstacles that may lie on the runway and cause damage to the wheel.

This patent wheel is an advancement in the state of the art of vehicle wheel development. For particular applications, the wheel component called the inner annular shock absorber may be a solid material shock absorber element, which may be made of a resilient solid rubber compound. The solid material can provide more shock resistant durability than a pneumatic element, but for long term continuous applications the solid material shock absorber will generate more internal frictional heat. Consequently, the pneumatic element is to be preferred for most continuous operation applications.

In the unlikely event of collapse or disintegration of the inner annular shock absorber element in this patent wheel, the outer annular rim will fit over the inner annular rim and provide a safety factor for the vehicle so that the wheel remains integral while remedial action is taken to retain control of the vehicle.

The solid rubber compound tread secured to the outer annular rim of the wheel is in contact with the roadbed. The selected type of tread is cut or molded into the hard rubber compound. One type of tread may be exchanged for another type by simply using a different tread and outer annular rim assembly. Therefore, for example, changing from a summer tread to a winter snow tread is a simple and inexpensive matter.

The entire patent wheel assembly is made for safe and long lasting use. The simple construction is cost effective and should not only make vehicle operation less expensive, but also a great deal safer than prior art.

I claim:

1. An inner annular shock absorber element located within the body of a vehicle wheel and between two concentric annular rims.

2. Said inner annular shock absorber element of claim 1 can be hollow and pressurized with air or gas.

3. Said inner annular shock absorber element of claim 1 can be made of solid resilient material.

4. Said concentric annular rims of claim 1 each has a concave surface that faces the opposing concentric annular rim.

5. Said outer concentric annular rim of claim 1 and claim 2 has a solid resilient material attached to the outer surface.
